(19) United States
(12) Patent Application Publication
(10) Pub. No.: US 2025/0353260 A1
(43) Pub. Date: Nov. 20, 2025

(54) CURVE-WISE SURFACE FLATTENING FOR COMPOSITE LAYUP

(71) Applicant: The Boeing Company, Arlington, VA (US)

(72) Inventors: Troy Winfree, Seattle, WA (US); Ryan K. H. Lam, Lynnwood, WA (US)

(21) Appl. No.: 18/663,995

(22) Filed: May 14, 2024

(51) Int. Cl. B29C 70/30; B29C 37/00; G06F 30/17; G06F 113/26; G06F 119/18

(52) U.S. Cl. CPC B29C 70/30; G06F 30/17; B29C 2037/903; G06F 2113/26; G06F 2119/18

(57) ABSTRACT

Methods of performing a curve-wise flattening to determine a two-dimensional ply shape are presented. Curves are traced on a first tensor product spline representing a three-dimensional part surface. The curves are reparameterized onto a parametric domain representative of a two-dimensional space. The curves are mapped to a second tensor product spline representing a flat table space while maintaining lengths of the curves between the first tensor product spline and the second tensor product spline in the curve-wise flattening to form a flattened shape, such that resulting table-space flattened curves are parallel straight lines in a desired fiber direction.

### BACKGROUND INFORMATION

### 1. Field

The present disclosure relates generally to curve flattening and more specifically methods of curve flattening for composite manufacturing.

### 2. Background

In aerospace composite design, a three-dimensional part is designed as a through-the-thickness build-up of layers, or plies, of composite material. Unidirectional plies of composite material each have a given fiber direction, ply shape, and position. The fiber direction can vary through-the-thickness so that the final part has the desired strength properties. The ply shape is also varied through-the-thickness.

In drape-formed composite manufacturing, each ply is cut out on a table and then formed to the three-dimensional part. Plies can be formed to the three-dimensional part either ply-by-ply or multiple plies at a time in a ply stack. The three-dimensional part is designed with the composite plies having desired shapes within the part. It is desirable to determine an initial shape for each composite ply on a flat cut-out table so that the initial shape will deform to the desired shape on the part. However, these determinations can be at least one of undesirably time-consuming or use an undesirable amount of resources.

Therefore, it would be desirable to have a method and apparatus that takes into account at least some of the issues discussed above, as well as other possible issues.

### SUMMARY

An embodiment of the present disclosure provides a method of performing a flattening to determine a two-dimensional ply shape. Curves are traced on a first tensor product spline representing a three-dimensional part surface. The curves are reparameterized onto a parametric domain representative of a two-dimensional space. The curves are flattened to a second tensor product spline representing a flat table space while maintaining lengths of the curves between the first tensor product spline and the second tensor product spline in the curve-wise flattening to form a flattened shape, such that resulting table-space flattened curves are parallel straight lines in a desired fiber direction.

Another embodiment of the present disclosure provides a method of performing a flattening to determine a two-dimensional ply shape. An index curve is set on a parametric surface. A curve flattening of the index curve is constructed. Curves are traced on the parametric surface relative to the index curve to form traced curves. A partial reparameterization map of the parametric surface whose isoparametric curves are the traced curves on the parametric surface is constructed. A flattening map is constructed by unraveling the traced curves along parallel straight lines indexed by the index curve.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of representative steps in performing a flattening to determine a two-dimensional ply shape in accordance with an illustrative embodiment;

FIGS. 4A and 4B are a flowchart of a method of performing a flattening to determine a two-dimensional ply shape in accordance with an illustrative embodiment;

FIG. 5 is a flowchart of a method of performing a flattening to determine a two-dimensional ply shape in accordance with an illustrative embodiment;

FIG. 6 is an illustration of an aircraft manufacturing and service method in a form of a block diagram in accordance with an illustrative embodiment; and

FIG. 7 is an illustration of an aircraft in a form of a block diagram in which an illustrative embodiment may be implemented.

### DETAILED DESCRIPTION

The illustrative examples recognize and take into account several considerations. The illustrative embodiments recognize and take into account that it is desirable to compute a shape on the ply cut-out table that will deform to a desired shape on the part. The illustrative embodiments recognize and take into account that computing a shape on the ply cut-out table is called ply “flat-patterning” or “flattening”.

The illustrative embodiments recognize and take into account that flattening is a challenging problem. The illustrative embodiments recognize and take into account that unidirectional composite material does not stretch or compress along the fiber directions. The illustrative embodiments recognize and take into account that unidirectional composite material can shear parallel to the fibers and can stretch perpendicular to the fibers.

The illustrative embodiments recognize and take into account that Detailed Finite Element Analysis (FEA) tools that attempt to predict how a ply or stack-up of plies deform under a manufacturing process are undesirably lengthy. The illustrative embodiments recognize and take into account that Detailed Finite Element Analysis (FEA) tools that attempt to predict how a ply or stack-up of plies deform under a manufacturing process can be undesirably challenging.

The illustrative embodiments recognize and take into account that in computer graphics, a host of flattening (sometimes called parameterization) methods have been developed to map two-dimensional textures to three-dimensional models. The illustrative embodiments recognize and take into account that parameterization methods do not incorporate inextensibility conditions along fiber directions. The illustrative embodiments recognize and take into account that parameterization methods focus on producing approximately conformal maps with as little over-all distortion as possible.

The illustrative examples present “curve-wise” flattening methods that trace fiber directions on a part surface and map them to fiber lines on the ply cut-out table. The illustrative examples produce flattenings that do not allow compression or stretching in the fiber direction. The illustrative examples are geometric methods, and as a result are fast to run. The illustrative examples do not incorporate material physics. The speed of the illustrative examples allows the curve-wise flattenings to fit easily into a design iteration process.

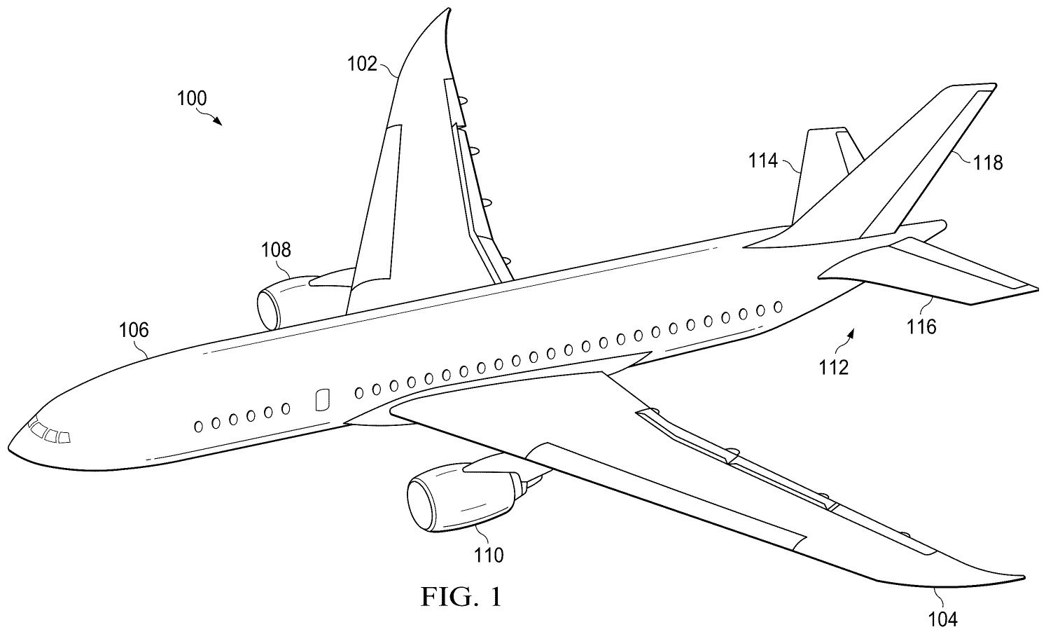

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can be designed using the flattening methods of the illustrative examples. Any of wing 102, wing 104, body 106, or tail section 112 can be manufactured using composite plies designed using the illustrative examples.

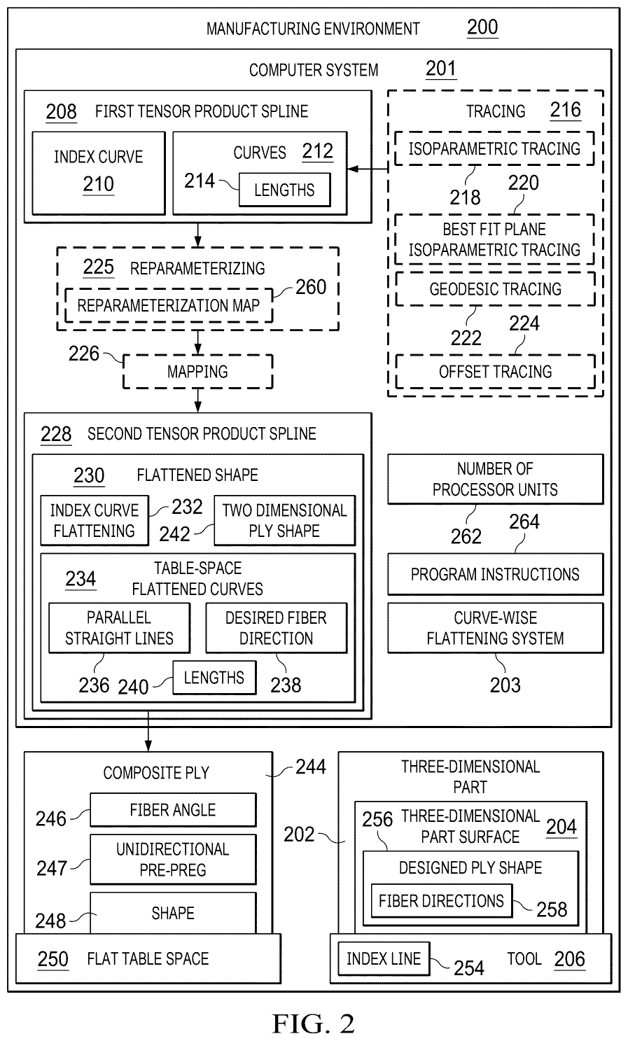

Turning now to FIG. 2, an illustration of a block diagram of a manufacturing environment is depicted in accordance with an illustrative embodiment. In manufacturing environment 200, composite ply 244 with fiber angle 246 can be laid up on flat table space 250 as a stage in manufacturing three-dimensional part 202. Composite ply 244 is formed of unidirectional prepreg 247. Unidirectional prepreg 247 is a pre-impregnated composite material with unidirectional fibers that are inextensible. Shape 248 of composite ply 244 is distorted as composite ply 244 is applied to tool 206. Composite ply 244 can be either directly or indirectly applied to tool 206. In some illustrative examples, composite ply 244 is applied to a surface of tool 206 as a first composite ply on tool 206. In other illustrative examples, composite ply 244 is applied to tool 206 by applying composite ply 244 onto other composite plies of three-dimensional part 202 already present on tool 206. After sweeping composite ply 244 onto tool 206, composite ply 244 has designed ply shape 256. Shape 248 is set based on two-dimensional ply shape 242 determined in a curve-wise flattening. The curve-wise flattening can be performed by curve-wise flattening system 203 in computer system 201. Although computer system 201 is depicted as within manufacturing environment 200, in other illustrative examples, computer system 201 can be positioned outside of manufacturing environment 200.

The curve-wise flattening performed by curve-wise flattening system 203 comprises tracing 216, reparameterizing 225, and mapping 226. The curve-wise flattening is performed to determine two-dimensional ply shape 242. Two-dimensional ply shape 242 will produce a desired shape, designed ply shape 256, when spread across tool 206 to form a ply in the lay-up of three-dimensional part 202. To determine two-dimensional ply shape 242, curves 212 are traced on first tensor product spline 208 representing three-dimensional part surface 204 in tracing 216. Three-dimensional part surface 204 is representative of composite ply 244 with designed ply shape 256 within three-dimensional part 202. Composite ply 244 is applied to tool 206 to form three-dimensional part surface 204. Curves 212 are representative of fibers within composite ply 244 having designed ply shape 256 in three-dimensional part surface 204.

Curves 212 are designed based on desired properties for three-dimensional part 202. In some illustrative examples, fiber directions in three-dimensional part surface 204, and thus curves 212 in first tensor product spline 208, are designed for at least one of strength or stiffness properties of three-dimensional part 202.

Curves 212 are flattened to second tensor product spline 228 representing flat table space 250 while maintaining lengths 214 of curves 212 in mapping 226 to form flattened shape 230, such that resulting table-space flattened curves 234 are parallel straight lines 236 in desired fiber direction 238. To perform the curve-wise flattening, reparameterizing 225 is performed to transition curves 212 from first tensor product spline 208 to second tensor product spline 228 using reparameterization map 260.

In some illustrative examples, desired fiber direction 238 is one of 0 degrees, 15 degrees, 30 degrees, 45 degrees, 60 degrees, 75 degrees, or 90 degrees. Desired fiber direction 238 is a direction of laying up fibers of unidirectional prepreg 247. By maintaining lengths 214 of curves 212, lengths 240 of table-space flattened curves 234 are the same as lengths 214 of curves 212 of first tensor product spline 208.

Tracing 216 curves 212 comprises at least one of isoparametric tracing 218, best fit plane isoparametric tracing 220, geodesic tracing 222, or offset tracing 224. Prior to tracing 216 curves 212 on first tensor product spline 208, index curve 210 is traced on first tensor product spline 208. In some illustrative examples, index curve 210 intersects each of curves 212. In some other illustrative examples, index curve 210 does not intersect any of curves 212. Prior to mapping 226 curves 212 to second tensor product spline 228, index curve flattening 232 for index curve 210 is defined.

In some illustrative examples, index curve 210 defines a location of a composite material that is fixed in a draping process of the composite material onto tool 206 to form three-dimensional part surface 204. In some illustrative examples, index curve 210 is the initial placement and sweeping location for composite ply 244 on tool 206. Index curve 210 may also be referred to as a fixed line, a clamp line, or a fixed initial position. In some illustrative examples, tracing 216 curves 212 comprises tracing 216 curves 212 relative to index curve 210 over first tensor product spline 208.

Mapping 226 can be performed using any desirable methods to determine two-dimensional ply shape 242. Reparameterization map 260 of first tensor product spline 208 is constructed whose isoparametric curves are curves 212 on the first tensor product spline 208. In some illustrative examples, wherein mapping 226 curves 212 to second tensor product spline 228 comprises constructing a flattening map by unraveling traced curves 212 along parallel straight lines indexed by index curve 210.

To manufacture a structure, composite ply 244 is laid up according to flattened shape 230. Afterwards, composite ply 244 having flattened shape 230 is applied onto index line 254 of tool 206 corresponding to index curve 210 on three-dimensional part surface 204. Composite ply 244 is then swept to tool 206. In some illustrative examples, sweeping composite ply 244 to tool 206 comprises pressing composite ply 244 to tool 206 by sweeping outward from index line 254.

Curve-wise flattenings work by tracing curves on a part surface and using a rule to flatten the curves to two-dimensional table-space. In these illustrative examples, tracing 216 is performed to generate curves 212, reparameterizing 225 transitions curves 212 between a three-dimensional parametric domain and a two-dimensional parametric domain.

Table-space flattened curves 234 are parallel straight lines 236 in desired fiber direction 238. The inextensibility of composite fibers is modeled by ensuring that the three-dimensional-to-two-dimensional curve mappings preserve lengths 240. A collection of part surface curves can present two questions: which two-dimensional straight line does a given three-dimensional curve get mapped to, and where along the straight line in two-dimensional should the three-dimensional curve be “unraveled” from? These questions are answered by index curve 210, whose flattening is known and which intersects all three-dimensional traced curves, curves 212. In some illustrative examples, index curve 210 is defined first together with index curve flattening 232, then curves 212 are traced from or relative to index curve 210 in first tensor product spline 208. In some illustrative examples, index curve 210 defines a location on the material that is fixed in the composite draping process.

In this document three-dimensional part surface 204 is a parametric surface S(u,v) and index curve 210 is a curve c(t)=(u(t),v(t)) into the parameter domain of S. Physical space coordinates are x,y,z, and flat table-space coordinates are x_{F}, y_{F}. To enable use of the CAD modeling software, the tensor product splines are used to represent parametric surface geometry and flattened regions in table-space. The parametric domain of tensor product splines is rectangular. Therefore, a two-dimensional to three-dimensional ply shape deformation can be modeled as a pair of tensor product splines, one representing the part surface, first tensor product spline 208, and a second representing the flat region in table-space, second tensor product spline 228. In curve-wise flattening the deformation additionally includes reparameterizing 225, which transitions curves 212 from the parameter domain of first tensor product spline 208, to the parameter domain of second tensor product spline 228. Reparameterizing 225 and second tensor product spline 228 share the same parametric domain. The additional spline function, reparameterizing 225, reparametrizes the subregion covered by curves 212 on the part surface; the subregion is the region that is flattened.

Curves on the surface are produced relative to the index curve S°c using a tracing rule. There are many possible tracing rules. There are many ways to construct a curve-wise flattening of S°c. One approach is to flatten by arc-length along a straight line. Specifically, let s be the arc length parameter of S°c and let p be a point and v a direction, both in flat table-space. Then the unraveling by arc length along the straight line given by p and v is just: c_{F}(s)=p+sv.

Another choice is to integrate the curvature of S°c. We take c_{F}(s)=[x_{F}(s),y_{F}(s)] and note that x′_{F}=cos θ and y′_{F}=sin θ where θ(s) is a function giving the angle of the tangent vector to c_{F} at s. The derivative of θ(s) is the curvature of c_{F}. So, if we want to compute c_{F} to match the curvature (or geodesic curvature) of S°c then we just need to solve the system of differential equations

$$\frac{d}{ds} [ \begin{matrix}θ \\ {x}_{F} \\ {y}_{F}\end{matrix} ] = [ \begin{matrix}κ \\ cos θ \\ sin θ\end{matrix} ] ,$$

where κ is the known curvature function of S°c.

Since S is a parameterized surface there two natural sets of curves on S: the isoparametric curves. Isoparametric curves are the curves on S that lie along constant u or v parameters. Without loss of generality we can focus on the constant along u case. Consider the set of isoparametric curves that intersect the index curve S°c. We assume that c has been chosen so that each isoparametric curve in the set intersects S°c exactly once. Since we are working with isoparametric curves along fixed u parameters, each curve in our set corresponds to a u parameter, let uₘ be the minimum such parameter and u_{M} the maximum. Let γᵤ be the isoparametric curve at the fixed u parameter of S. Let t(u) be the function that maps a u parameter of S to the parameter value of c_{F} corresponding to the intersection of c with γᵤ. Note that the domain of t(u) is [uₘ, u_{M}]. Let s(u) be the function that maps a parameter point of S to the arc length parameter of γᵤ corresponding to its intersection with c. Finally, let α(u,v) be the arc length of γᵤ on [0,v], and let θ(u) be the angle between γᵤ and S°c at their intersection. Then τ is just the identity map on the restricted parametric rectangle J=[uₘ, u_{M}]×[0,1].

For isoparametric tracing 218, tracing 216 can be performed without a separate reparameterizing 225. Because the below equation for isoparametric tracing 218 is the identity, there is no tau equation for reparameterizing 225. In some illustrative examples, isoparametric tracing 218 can be performed according to:

$${S}_{F} ( u , v ) = {c}_{F} ( t ( u ) ) + ( ∝ ( u , v ) - s ( u ) ) [ \begin{matrix}cos ( θ ( u ) ) \\ sin ( θ ( u ) )\end{matrix} ] {S}_{F}$$

is the flattening map on a same parameter domain as the parametric surface S, c_{F} is the curve flattening of the index curve, τ is a function from the u parameter of the surface that gives a location of an intersection of the isoparametric curve at u with the index curve, as a parameter point in a parameter space of c_{F}, S is a function from the u parameter of the parametric surface that gives arc length along the isoparametric curve at u at its intersection with the index curve, α is an arc length along the isoparametric curve at u at its v parameter location, and θ is the angle between the isoparametric curve at u and the index curve; wherein S(u,v) is a parameterized surface, the index curve is a curve c(t)=(u(t),v(t)) into the parameter domain of S. Physical space coordinates are x,y,z, and flat table-space coordinates are x_{F}, y_{F}. Note that in this case u_{F},v_{F}=u,v.

For best fit plane isoparametric tracing 220, a variation of the above equations can use S's best fit plane to define flat table-space. In this case, c_{F} is the projection of c to the best fit plane and θ(u) can be taken to be the angle between c_{F} and the projection of γᵤ in the best fit plane. In both cases it is possible to produce flattened isoparametric curves that intersect in table-space, however, this is undesirable since that leads to a non-invertible flattening map S_{F}.

As another method of tracing 216, geodesic tracing 222 can be used. In this approach, the method shoots geodesics from the index curve S°c. Geodesics are minimal energy curves on a surface that can be computed by integrating an initial value problem. In these illustrative examples, for geodesic tracing 222, composite fiber paths are modeled on the surface with geodesics, which can be generalized to allowing the fibers to go where the surface wants them to go (in a minimal energy sense). Geodesic tracing 222 will provide guidance. Unidirectional composite material can be made up of long composite fibers in a matrix of epoxy which does restrict movement of the fibers in the perpendicular and shear directions, preventing the fibers from following geodesic paths in practice. Nonetheless, using geodesics to model the fibers shows where the fibers “want” to go, which can provide useful manufacturability insight. Additionally, with less curvature in the plies, fibers can approximately follow geodesic paths. Note that geodesics can intersect which is undesirable since that leads to a non-invertible reparameterization map τ. If τ is not invertible, then ply shapes cannot be flat patterned through the flattening map.

Directions along the index curve S°c are defined to shoot geodesics. Because fiber directions which are at fixed angles in flat table-space are being modeled, one approach is to use the angle formed between the flattened index curve c_{F} and a given fixed table-space direction. Some standard table-space directions in composite manufacturing are 0°, +45°, and 90°. Let up be the shared parameter of c and c_{F} and let θ(u_{F}) be the function giving the angle between the tangent direction of c_{F} at u_{F} and a fixed table-space direction. So that geodesics are not traced along the same direction as the index curve, we assume that θ(u_{F}) never equals zero. Let gᵤ_{_{F}} bet the geodesic on S with start point c(u_{F}) and start direction θ(u_{F}), relative to the tangent direction of c at u_{F} and the surface normal. We take gᵤ_{_{F}} to be the geodesic in both the positive and negative directions. Since gᵤ_{_{F}} is a curve on the parameterized surface S, there is a parameter space map γᵤ^{F} such that gᵤ_{_{F}}=S°γᵤ_{_{F}}. Finally, let v_{F} be the arc length parameter along gᵤ_{_{F}}. We take v_{F} to be positive for the geodesic trace in the positive direction and negative for the trace in the negative direction.

In geodesic tracing 222, there is a reparameterization map that defines flat parameters u_{F} and v_{F}. For geodesic tracing 222, reparameterizing 225 is defined by:

$$τ ( {u}_{F} , {v}_{F} ) = {γ}_{{u}_{F}} ( {v}_{F} )$$

Wherein τ: is reparameterization map 260 from flat parameters u_{F} and v_{F} to the surface parameters u and v. u_{F}: is the parameter of index curve 210 and index curve flattening 232, c_{F}. γᵤ_{_{F}} is the surface parameter space map of the geodesic traced on the surface from index curve 210 at u_{F} (so the geodesic is S°γᵤ_{_{F}}). v_{F} is the arc-length parameter of γᵤ_{_{F}}.

In these illustrative examples, the surface flattening map, mapping 226, is defined by

$${S}_{F} ( {u}_{F} , {v}_{F} ) = {c}_{F} ( {u}_{F} ) + {v}_{F} [ \begin{matrix}cos ( θ ( {u}_{F} ) ) \\ sin ( θ ( {u}_{F} ) )\end{matrix} ]$$

wherein S_{F} is the flattening map, mapping 226, for geodesic tracing 222. In this illustrative example, Sp is defined on the reparameterization of the parameter domain of the surface S given by τ. c_{F} is index curve flattening 232 of the index curve 210. θ is an angle between c_{F} and a fixed direction in table space (typically 0″, +45°, or 90°)

In some illustrative examples, c_{F} is a straight line in table space parallel to one of the fiber directions. When c_{F} is a straight line in table space parallel to one of the fiber directions, it's not possible to trace geodesics in the aligned fiber direction. Instead of using geodesics in these illustrative examples, offset tracing 224 can be performed. In some of these illustrative examples, instead of using geodesics offset curves of S°c can be used on the surface to represent fiber paths and flatten those. Surface offsets are expensive to compute but can be approximated by evaluating fixed length (the offset length) points along geodesics perpendicular to the index curve.

Let wᵥ_{_{F}}=S°ωᵥ_{_{F}} be the offset of S°c by distance v_{F}. As before we are allowing v_{F} to be positive or negative, corresponding to offsets above or below the index curve relative to the tangent and curve normal directions. So wᵥ_{_{F}} will be mapped to offsets of c_{F} in flat table-space in a way that preserves arc length. Note that wᵥ_{_{F}} can be shorter or longer than S°c, depending on the shape of S and the location of c. The possible ways to unravel wᵥ_{_{F}} along an offset are parameterized by the location along the table-space offset that the point wᵥ_{_{F}}(0) is mapped to, since once that location is known it only remains to trace along the table space offset to the arc length of wᵥ_{_{F}}. To choose these points we set up an optimization problem on a discretized version of the problem. Before moving on to a discussion of the optimization problem, note that if u_{F} is the arc length parameter of wᵥ_{_{F}} then the reparameterization map 260 for offset tracing 224 is:

$$τ ( {u}_{F} , {v}_{F} ) = {ω}_{{v}_{F}} ( {u}_{F} ) .$$

Wherein ωᵥ_{_{F}} is the surface parameter space map of the offset on the surface of the index map by a distance of v_{F}. u_{F} is the arc length parameter of the surface offset at v_{F}. Furthermore if μᵥ_{_{F}} is the arc length parameterized v_{F}-offset of c_{F} in flat table-space and flattening parameter locations are fixed {u*_{F}} for wᵥ_{_{F}}(0) then the mapping 226 is

$${S}_{F} ( {u}_{F} , {v}_{F} ) = {μ}_{{v}_{F}} ( {u}_{F}^{*} + {u}_{F} ) .$$

wherein S_{F} is the flattening map, μᵥ_{_{F}} is a arc-length parameterized v_{F}-offset of c_{F} in table-space, and u*_{F} is a fixed parameter location along the v_{F}-offset. Moving on to the optimization to compute {u*_{F}}, fix a set {vᵢ} of sorted non-zero (though possibly negative) offset distances. Also fix a set {u₀ⱼ} of sorted values in the shared parameter space of c and c_{F}. The perpendicular geodesics at {u₀ⱼ} form a non-linear grid on S. Let uᵢⱼ be the arc-length parameter location for the offset wᵥ_{ᵢ} of its intersection with the j-th geodesic. Finally, let vₙ be the largest negative offset value. The optimization objective function is formed from three parts:

$${\sum }_{0} ( {u}_{0} , … , {\hat{u}}_{n} , … , {u}_{m} ) = {\sum }_{\begin{matrix}i \neq n \\ j\end{matrix}} \frac{〈 {μ}_{{v}_{i + 1}} ( {u}_{i + 1} + {u}_{i + 1 j} ) - {μ}_{{v}_{i}} ( {u}_{i} + {u}_{ij} ) , {μ}_{{v}_{i}}^{′} ( {u}_{i} + {u}_{ij} ) 〉}{{v}_{i + 1} - {v}_{i}}$$

$${\sum }_{1} ( {u}_{n} ) = {\sum }_{j} \frac{〈 {c}_{F} ( {u}_{0 j} ) - {μ}_{{v}_{n}} ( {u}_{n} + {u}_{nj} ) , {μ}_{{v}_{n}}^{′} ( {u}_{n} + {u}_{nj} ) 〉}{- {v}_{n}}$$

$${\sum }_{2} ( {u}_{n + 1} ) = {\sum }_{j} \frac{〈 {μ}_{{v}_{n + 1}} ( {u}_{n + 1} + {u}_{n + 1 j} ) - {c}_{F} ( {u}_{0 j} ) , {c}_{F}^{′} ( {u}_{0 j} ) 〉}{{v}_{n + 1}}$$

Each part has the same form: we are asking that the locations on adjacent offsets be aligned as much as possible along the perpendicular directions to the offset curves. Σ₁ and Σ₂ are dealt with separately because of the special notational status of c_{F}. The variables are {uᵢ}: they determine where along table-space offset curves the physical space curves are unraveled from. Because these summands only deal with alignment along perpendicular directions, it's possible for the distance between points on adjacent table-space offsets to be quite large. The illustrative examples can add additional terms to balance physical space distance as well if desired. The simple unconstrained optimization problem is:

$${min}_{{u}_{i}} {\sum }_{0} + {\sum }_{1} + {\sum }_{2} .$$

Let {u*ᵢ} be a solution to the optimization problem, then the illustrative examples can use the samples {S_{F}(uᵢⱼ,vᵢ)=μᵥ_{_{F}}(u*ᵢ+uᵢⱼ)}_{i,j} to fit an approximation to S_{F}.

In this depicted example, curve-wise flattening system 203 is located in computer system 201 and can be implemented in software, hardware, firmware, or a combination thereof. When software is used, the operations performed by curve-wise flattening system 203 can be implemented in program instructions configured to run on hardware, such as a processor unit. When firmware is used, the operations performed by curve-wise flattening system 203 can be implemented in program instructions and data stored in persistent memory to run on a processor unit. When hardware is employed, the hardware can include circuits that operate to perform the operations in curve-wise flattening system 203.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices.

Computer system 201 is a physical hardware system and includes one or more data processing systems. When more than one data processing system is present in computer system 201, those data processing systems are in communication with each other using a communications medium. The communications medium can be a network. The data processing systems can be selected from at least one of a computer, a server computer, a tablet computer, or some other suitable data processing system.

As depicted, computer system 201 includes a number of processor units 262 that are capable of executing program instructions 264 implementing processes for curve-wise flattening system 203 in the illustrative examples. In other words, program instructions 264 are computer-readable program instructions.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

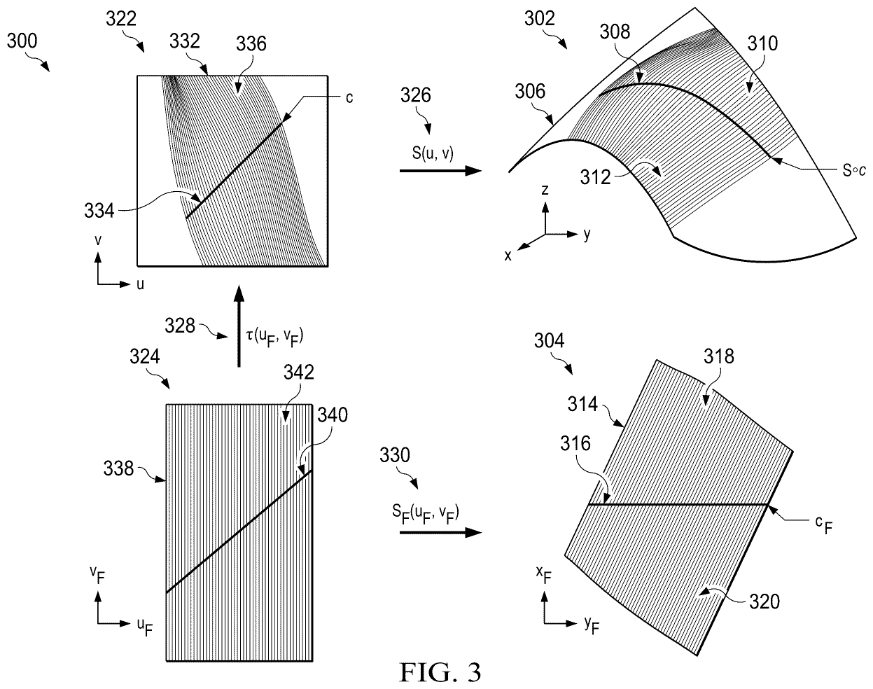

Turning now to FIG. 3, an illustration of representative steps in performing a flattening to determine a two-dimensional ply shape is depicted in accordance with an illustrative embodiment. View 300 is an illustration of a part surface and a two-dimensional ply shape and curve-wise flattening between. In view 300, three-dimensional part surface 302 is an example of three-dimensional part surface 204 of FIG. 2. Three-dimensional part surface 302 has designed ply shape 306. Index curve 308 extends across part surface 302 and intersects each of curves 310. Curves 310 have lengths 312.

The curve-wise flattening is performed by tracing using first tensor product spline 326, reparameterization 328, and mapping using second tensor product spline 330.

Tracing using first tensor product spline 326 is representative of tracing 216 of FIG. 2. In this illustrative example, arrows in FIG. 3 are representative of spline maps. A collection of curves on the part surface are produced whose image in the parametric domain of the part surface form the image of the reparameterization map, t. The parametric domain of reparameterization 328, t, is also the parametric domain of the flattening map, second tensor product spline 330, S_{F}.

As depicted, three-dimensional part surface 302 is a parametric surface S(u,v) and index curve 308 is a curve c(t)=(u(t),v(t)) into the parameter domain of S. Physical space coordinates are x,y,z, and flat table-space coordinates are x_{F},y_{F}.

Three-dimensional part surface 302 is only representative of the resulting three-dimensional layer created in a structure. Designed ply shape 306 is set and curves 310 are traced based on desired ply properties.

Flattened shape 304 is a result of the curve-wise flattening. Flattened shape 304 is representative of an output of the curve-wise flattening process. Flattened shape 304 comprises two-dimensional ply shape 314 with index curve flattening 316 and table-space flattened curves 318 that are parallel straight lines with desired fiber direction and lengths 320.

Parametric domain 322 is representative of the three-dimensional parametric domain of three-dimensional part surface 302. Parametric domain 322 is rectangular. In this illustrative example, index curve 334 intersects curves 332 with lengths 336. Parametric domain 322 is representative of the parametric domain of first tensor product spline 326. In this illustrative example, lengths 312 are the same as lengths 320. Lengths of fibers are maintained between three-dimensional part surface 302 and flattened shape 304 by the curve-wise flattening utilizing tracing using first tensor product spline 326, reparameterization 328, and mapping using second tensor product spline 330.

Parametric domain 324 is representative of the two-dimensional parametric domain of flattened shape 304. Parametric domain 324 is rectangular. In this illustrative example, index curve 340 intersects curves 338 with lengths 342. Parametric domain 324 is representative of the parametric domain of second tensor product spline 330. To move between parametric domain 322 and parametric domain 324, reparameterization 328 uses a partial reparameterization map to unravel traced curves 332 along parallel straight lines indexed by index curve 334.

Second tensor product spline 330 transforms traced curves 338 in parametric domain 324 by aligning them with a fixed fiber direction in flattened shape 304 and matching lengths with physical space traced curves 310.

In some illustrative examples, the curve-wise flattening can be performed using CAD modeling software. To enable use of the CAD modeling software, the tensor product splines are used to represent parametric surface geometry and flattened regions in table-space.

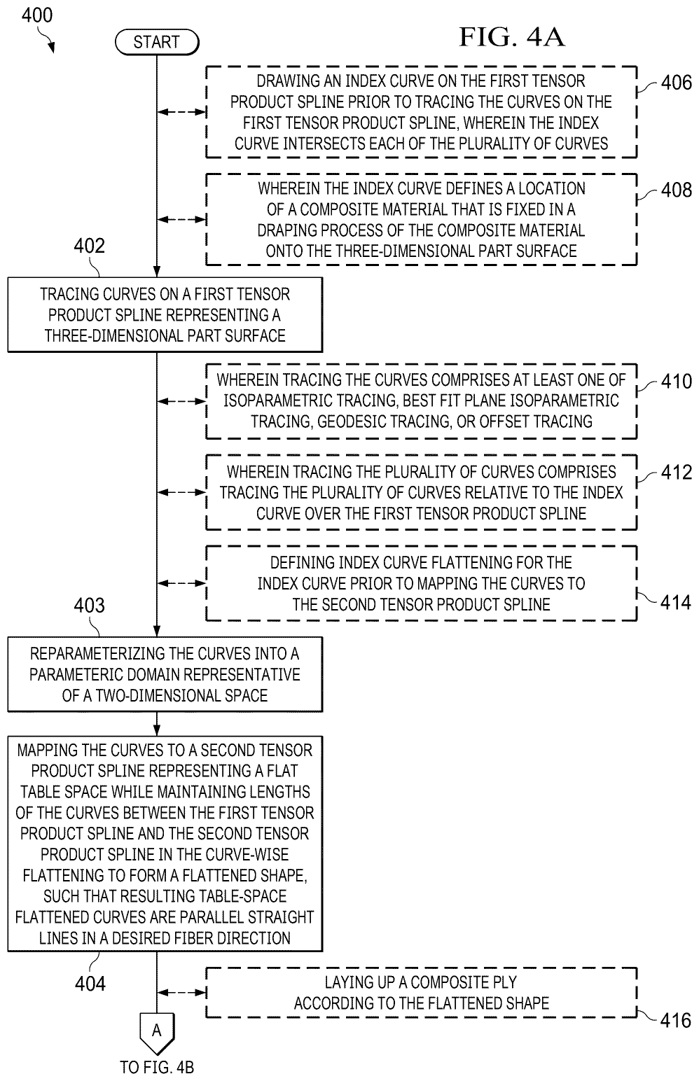

Turning now to FIGS. 4A and 4B, a flowchart of a method of performing a flattening to determine a two-dimensional ply shape is depicted in accordance with an illustrative embodiment. Some operations of method 400 can be implemented in hardware, software, or both. When implemented in software, the respective operation can take the form of program instructions that are run by one of more processor units located in one or more hardware devices in one or more computer systems. Method 400 can be performed to determine two-dimensional ply shape 242 of FIG. 2. In some illustrative examples, method 400 is a method of performing a flattening as in view 300 of FIG. 3.

Method 400 traces a curves on a first tensor product spline representing a three-dimensional part surface (operation 402). Method 400 reparameterizes the curves into a parametric domain representative of a two-dimensional space (operation 403). Method 400 maps the curves to a second tensor product spline representing a flat table space while maintaining lengths of the curves between the first tensor product spline and the second tensor product spline in the curve-wise flattening to form a flattened shape, such that resulting table-space flattened curves are parallel straight lines in a desired fiber direction (operation 404). Afterwards, method 400 terminates.

In some illustrative examples, method 400 draws an index curve on the first tensor product spline prior to tracing the curves on the first tensor product spline, wherein the index curve intersects each of the curves (operation 406). In some illustrative examples, the index curve defines a location of a composite material that is fixed in a draping process of the composite material onto a three-dimensional part surface. In some illustrative examples, the index curve is the initial placement and sweeping location for composite ply on the tool. The index curve may also be referred to as a fixed line, a clamp line, or a fixed initial position.

In some illustrative examples, the index curve defines a location of a composite material that is fixed in a draping process of the composite material onto the three-dimensional part surface (operation 408). In some illustrative examples, tracing the curves comprises at least one of isoparametric tracing, best fit plane isoparametric tracing, geodesic tracing, or offset tracing (operation 410).

In some illustrative examples, tracing the curves comprises tracing the curves relative to the index curve over the first tensor product spline (operation 412). In some illustrative examples, method 400 defines index curve flattening for the index curve prior to mapping the curves to the second tensor product spline (operation 414).

In some illustrative examples, method 400 lays up a composite ply according to the flattened shape (operation 416). In these illustrative examples, the composite ply is laid up as a unidirectional pre-preg ply with a fiber angle that corresponds to the desired fiber direction in the table-space flattened curves.

In some illustrative examples, method 400 applies a composite ply having the flattened shape onto an index line of a tool corresponding to the index curve on the three-dimensional part surface (operation 418). In some illustrative examples, method 400 sweeps the composite ply to the tool (operation 420). In some illustrative examples, sweeping the composite ply to the tool comprises pressing the composite ply to the tool by sweeping outward from the index line (operation 422).

In some illustrative examples, method 400 constructs a partial reparameterization map of the first tensor product spline whose isoparametric curves are the curves on the first tensor product spline, and wherein mapping the curves to the second tensor product comprises constructing a flattening map by unraveling the traced curves along parallel straight lines indexed by the index curve (operation 424).

In some illustrative examples, the desired fiber direction is one of 0 degrees, 15 degrees, 30 degrees, 45 degrees, 60 degrees, 75 degrees, or 90 degrees (operation 426). The desired fiber direction can be any designed fiber direction for composite manufacturing.

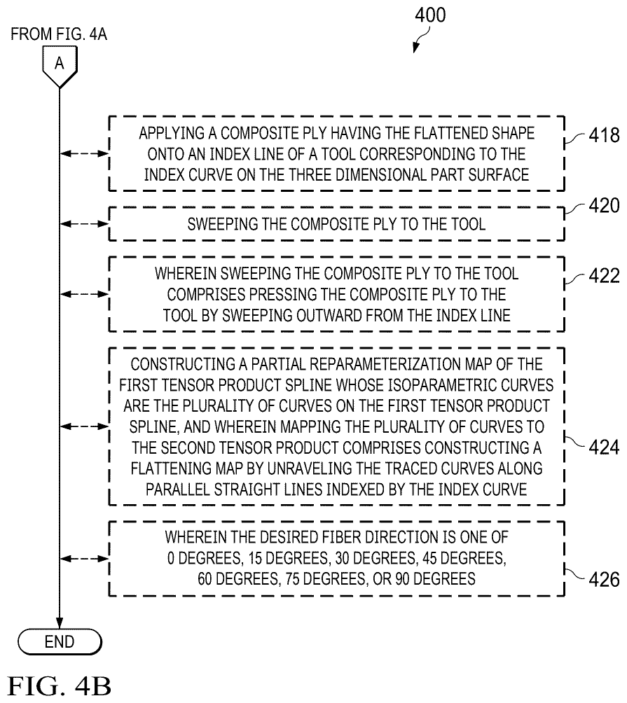

Turning now to FIG. 5 is a flowchart of a method of performing a flattening to determine a two-dimensional ply shape is depicted in accordance with an illustrative embodiment. Some operations of method 500 can be implemented in hardware, software, or both. When implemented in software, the respective operation can take the form of program instructions that are run by one of more processor units located in one or more hardware devices in one or more computer systems. Method 500 can be performed to determine two-dimensional ply shape 242 of FIG. 2. In some illustrative examples, method 500 is a method of performing a flattening as in view 300 of FIG. 3.

Method 500 sets an index curve on a parametric surface (operation 502). Method 500 constructs a curve flattening of the index curve (operation 504). Method 500 traces curves on the parametric surface relative to the index curve to form traced curves (operation 506). Method 500 constructs a partial reparameterization map of the parametric surface whose isoparametric curves are the traced curves on the parametric surface (operation 508). Method 500 constructs a flattening map by unraveling the traced curves along parallel straight lines indexed by the index curve (operation 510). Afterwards, method 500 terminates.

In some illustrative examples, tracing curves on the parametric surface comprises isoparametric tracing (operation 512). In the isoparametric tracing, the distances are preserved along the traced curves due to the inextensible nature of the composite fibers. In the isoparametric tracing, the distances in other non-fiber directions are not preserved. In some illustrative examples, the isoparametric tracing is performed according to

$${S}_{F} ( u , v ) = {c}_{F} ( t ( u ) ) + ( ∝ ( u , v ) - s ( u ) ) [ \begin{matrix}cos ( θ ( u ) ) \\ sin ( θ ( u ) )\end{matrix} ] ,$$

wherein
S_{F} is the flattening map on a same parameter domain as the parametric surface S, c_{F} is the curve flattening of the index curve, τ is a function from the u parameter of the surface that gives a location of an intersection of the isoparametric curve at u with the index curve, as a parameter point in a parameter space of c_{F}, S is a function from the u parameter of the parametric surface that gives arc length along the isoparametric curve at u at its intersection with the index curve,
α is an arc length along the isoparametric curve at u at its v parameter location, and θ is the angle between the isoparametric curve at u and the index curve; wherein S(u,v) is a parameterized surface, the index curve is a curve c(t)=(u(t),v(t)) into the parameter domain of S. Physical space coordinates are x,y,z, and flat table-space coordinates are x_{F},y_{F}.

In some illustrative examples, the isoparametric tracing comprises a best fit plane isoparametric flattening (operation 514). In some illustrative examples, tracing curves on the parametric surface comprises geodesic tracing (operation 516). In some illustrative examples, the geodesic tracing is performed according to:

$${S}_{F} ( {u}_{F} , {v}_{F} ) = {c}_{F} ( {u}_{F} ) + {v}_{F} [ \begin{matrix}cos ( θ ( {u}_{F} ) ) \\ sin ( θ ( {u}_{F} ) )\end{matrix} ] ,$$

wherein S_{F} is the flattening map, c_{F} is the curve flattening of the index curve, and θ is an angle between c_{F} and a fixed direction in table space; and
wherein constructing the reparameterization map is performed according to:

$$τ ( {u}_{F} , {v}_{F} ) = {γ}_{{u}_{F}} ( {v}_{F} ) ,$$

τ is the reparameterization map from flat parameters u_{F} and v_{F} to surface parameters u and v, u_{F} is the index curve, γᵤ_{_{F}} is a surface parameter space map of the geodesic traced on the surface from the index curve at u_{F} so that the geodesic is S°γᵤ_{_{F}}, and v_{F}: arc-length parameter of γᵤ_{_{F}}.

In some illustrative examples, tracing curves on the parametric surface comprises offset tracing (operation 518). In some illustrative examples, the offset tracing is performed using:

$${S}_{F} ( {u}_{F} , {v}_{F} ) = {μ}_{{v}_{F}} ( {u}_{F}^{*} + {u}_{F} ) ,$$

wherein S_{F} is the flattening map, μᵥ^{F}, is the arc-length parameterized v_{F}-offset of the flattened index curve in table-space, and u*_{F} is a fixed parameter location along the v_{F}-offset; and wherein constructing the reparameterization map comprises:

$$τ ( {u}_{F} , {v}_{F} ) = {ω}_{{u}_{F}} ( {u}_{F} )$$

wherein ωᵤ_{_{F}} is the surface parameter space map of the offset tracing on a surface of an index map by a distance of v_{F}, u_{F} is the arc length parameter of the surface offset at v_{F}.

In some illustrative examples, method 500 lays up a composite ply according to the flattening map (operation 520). In some illustrative examples, method 500 applies the composite ply onto an index line of a tool corresponding to the index curve (operation 522). In some illustrative examples, method 500 sweeps the composite ply to the tool (operation 524).

As used herein, the phrase “at least one of,” when used with a list of items, means different combinations of one or more of the listed items may be used and only one of each item in the list may be needed. For example, “at least one of item A, item B, or item C,” may include, without limitation, item A, item A and item B, or item B. This example also may include item A, item B, and item C, or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 406 through operation 426 may be optional. As another example, operation 512 through operation 524 may be optional.

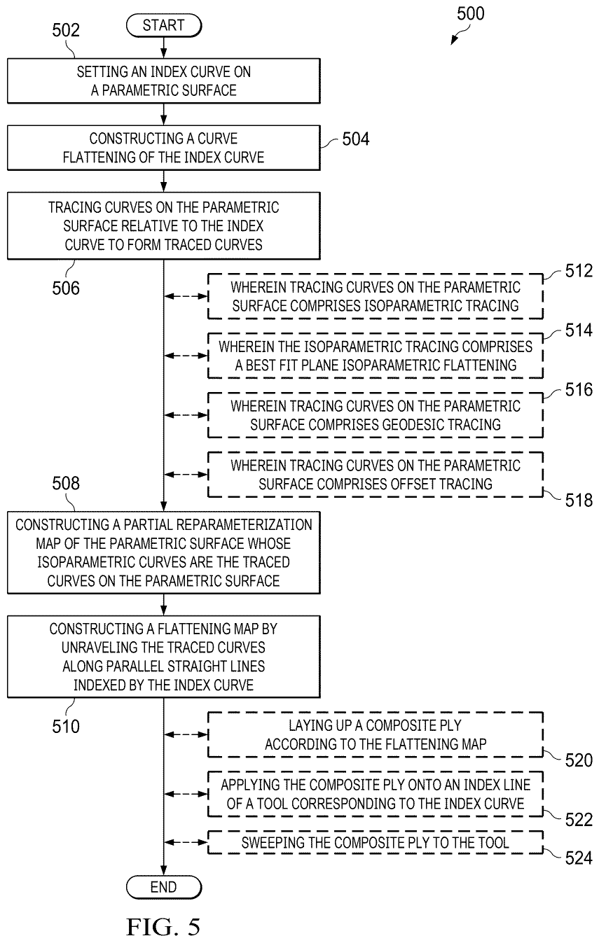

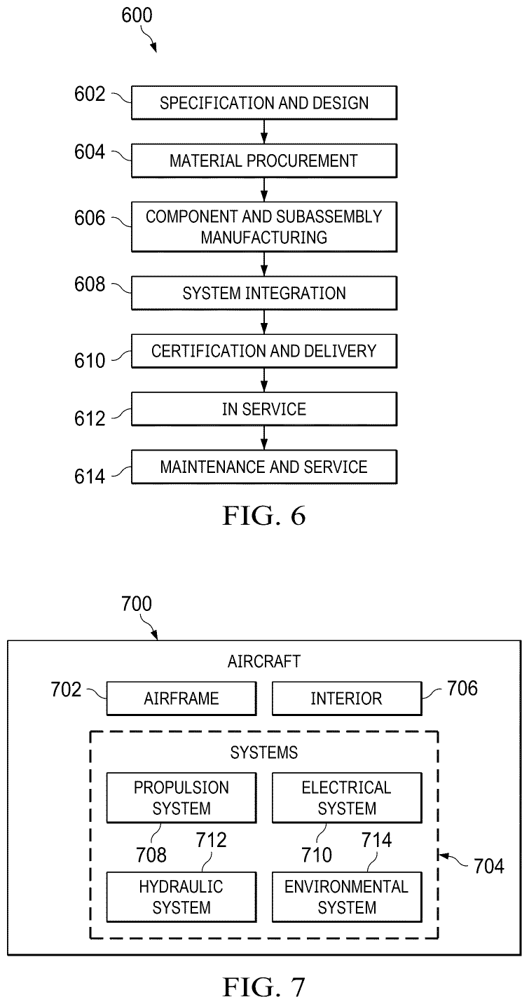

Illustrative embodiments of the present disclosure may be described in the context of aircraft manufacturing and service method 600 as shown in FIG. 6 and aircraft 700 as shown in FIG. 7. Turning first to FIG. 6, an illustration of an aircraft manufacturing and service method in a form of a block diagram is depicted in accordance with an illustrative embodiment. During pre-production, aircraft manufacturing and service method 600 may include specification and design 602 of aircraft 700 in FIG. 7 and material procurement 604.

During production, component and subassembly manufacturing 606 and system integration 608 of aircraft 700 takes place. Thereafter, aircraft 700 may go through certification and delivery 610 in order to be placed in service 612. While in service 612 by a customer, aircraft 700 is scheduled for routine maintenance and service 614, which may include modification, reconfiguration, refurbishment, or other maintenance and service.

Each of the processes of aircraft manufacturing and service method 600 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 7, an illustration of an aircraft in a form of a block diagram is depicted in which an illustrative embodiment may be implemented. In this example, aircraft 700 is produced by aircraft manufacturing and service method 600 of FIG. 6 and may include airframe 702 with plurality of systems 704 and interior 706. Examples of systems 704 include one or more of propulsion system 708, electrical system 710, hydraulic system 712, and environmental system 714. Any number of other systems may be included.

Apparatuses and methods embodied herein may be employed during at least one of the stages of aircraft manufacturing and service method 600. One or more illustrative embodiments may be manufactured or used during at least one of component and subassembly manufacturing 606, system integration 608, in service 612, or maintenance and service 614 of FIG. 6.

The illustrative examples provide faster and easier curve flattenings compared to Finite Element Modeling (FEM) or physics-based methods. The illustrative examples provide flattenings using only geometric based decisions. Triangulated meshes are unable to provide flattenings for composite plies as the triangulated meshes do not account for fiber direction. The illustrative examples provide flattenings that account for fiber direction. The illustrative examples operate based on parametric geometry. The flattening of the illustrative examples is built on parametric shapes based on design geometry.

In the illustrative examples, the fiber directions are traced on a three-dimensional surface representing the part surface and then a rule is implemented on how to flatten the fiber directions along with the other fiber directions in the layer.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of performing a curve-wise flattening to determine a two-dimensional ply shape, the method comprising:
tracing curves on a first tensor product spline representing a three-dimensional part surface;
reparameterizing the curves onto a parametric domain representative of a two-dimensional space; and
mapping the curves to a second tensor product spline representing a flat table space while maintaining lengths of the curves between the first tensor product spline and the second tensor product spline in the curve-wise flattening to form a flattened shape, such that resulting table-space flattened curves are parallel straight lines in a desired fiber direction.

2. The method of claim 1, wherein tracing the curves comprises at least one of isoparametric tracing, best fit plane isoparametric tracing, geodesic tracing, or offset tracing.

3. The method of claim 1 further comprising:
drawing an index curve on the first tensor product spline prior to tracing the curves on the first tensor product spline, wherein the index curve intersects each of the curves; and
defining index curve flattening for the index curve prior to mapping the curves to the second tensor product spline.

4. The method of claim 3, wherein the index curve defines a location of a composite material that is fixed in a draping process of the composite material onto the three-dimensional part surface.

5. The method of claim 3, wherein tracing the curves comprises tracing the curves relative to the index curve over the first tensor product spline.

6. The method of claim 1 further comprising:
laying up a composite ply according to the flattened shape.

7. The method of claim 3 further comprising:
applying a composite ply having the flattened shape onto an index line of a tool corresponding to the index curve on the three-dimensional part surface; and
sweeping the composite ply to the tool.

8. The method of claim 7, wherein sweeping the composite ply to the tool comprises pressing the composite ply to the tool by sweeping outward from the index line.

9. The method of claim 3, wherein reparameterizing the curves onto the parametric domain representative of the two-dimensional space comprises constructing a partial reparameterization map of the first tensor product spline whose isoparametric curves are the curves on the first tensor product spline, and wherein mapping the curves to the second tensor product comprises constructing a flattening map by unraveling the traced curves along parallel straight lines indexed by the index curve.

10. The method of claim 1, wherein the desired fiber direction is one of 0 degrees, 15 degrees, 30 degrees, 45 degrees, 60 degrees, 75 degrees, or 90 degrees.

11. A method of performing a flattening to determine a two-dimensional ply shape, the method comprising:
setting an index curve on a parametric surface;
constructing a curve flattening of the index curve;
tracing curves on the parametric surface relative to the index curve to form traced curves;
constructing a reparameterization map of the parametric surface whose isoparametric curves are the traced curves on the parametric surface; and
constructing a flattening map by unraveling the traced curves along parallel straight lines indexed by the index curve.

12. The method of claim 11, wherein tracing curves on the parametric surface comprises isoparametric tracing.

13. The method of claim 12, wherein the isoparametric tracing comprises a best fit plane isoparametric flattening.

14. The method of claim 12, wherein the isoparametric tracing is performed according to
$${S}_{F} ( u , v ) = {c}_{F} ( t ( u ) ) + ( ∝ ( u , v ) - s ( u ) ) [ \begin{matrix}cos ( θ ( u ) ) \\ sin ( θ ( u ) )\end{matrix} ] ,$$
wherein
S_{F} is the flattening map on a same parameter domain as parametric surface S, c_{F} is the curve flattening of the index curve, τ is a function from u parameter of the surface that gives a location of an intersection of the isoparametric curve at u with the index curve, as a parameter point in a parameter space of c_{F}, S is a function from the u parameter of the parametric surface that gives arc length along the isoparametric curve at u at its intersection with the index curve,
α is an arc length along the isoparametric curve at u at its v parameter location, and θ is an angle between the isoparametric curve at u and the index curve; wherein S(u,v) is a parameterized surface, the index curve is a curve c(t)=(u(t),v(t)) into the parameter domain of S. Physical space coordinates are x,y,z, and flat table-space coordinates are x_{F},y_{F}.

15. The method of claim 11, wherein tracing curves on the parametric surface comprises geodesic tracing.

16. The method of claim 15, wherein the geodesic tracing is performed according to:
$${S}_{F} ( {u}_{F} , {v}_{F} ) = {c}_{F} ( {u}_{F} ) + {v}_{F} [ \begin{matrix}cos ( θ ( {u}_{F} ) ) \\ sin ( θ ( {u}_{F} ) )\end{matrix} ] ,$$
wherein S_{F} is the flattening map, c_{F} is the curve flattening of the index curve, and θ is an angle between c_{F} and a fixed direction in table space; and
wherein constructing the reparameterization map is performed according to:
$$τ ( {u}_{F} , {v}_{F} ) = {γ}_{{u}_{F}} ( {v}_{F} ) ,$$
wherein
τ is the reparameterization map from flat parameters u_{F} and v_{F} to surface parameters u and v, u_{F} is the index curve, γᵤ_{_{F}} is a surface parameter space map of the geodesic traced on the surface from the index curve at u_{F} so that the geodesic is S°γᵤ_{_{F}}, and v_{F}: arc-length parameter of γᵤ_{_{F}}.

17. The method of claim 11, wherein tracing curves on the parametric surface comprises offset tracing.

18. The method of claim 17, wherein the offset tracing is performed using
$${S}_{F} ( {u}_{F} , {v}_{F} ) = {μ}_{{v}_{F}} ( {u}_{F}^{*} + {u}_{F} ) ,$$
wherein S_{F} is the flattening map, μᵥ_{_{F}} is the arc-length parameterized v_{F}-offset of the curve flattening of the index curve in table-space, and u*_{F} is a fixed parameter location along the v_{F}-offset; and
wherein constructing the reparameterization map comprises:
$$τ ( {u}_{F} , {v}_{F} ) = {ω}_{{u}_{F}} ( {u}_{F} )$$
wherein ωᵤ_{_{F}} is a surface parameter space map of the offset tracing on a surface of an index map by a distance of v_{F}, u_{F} is the arc length parameter of the surface offset at v_{F}.

19. The method of claim 11 further comprising:
laying up a composite ply according to the flattening map.

20. The method of claim 19 further comprising:
applying the composite ply onto an index line of a tool corresponding to the index curve; and
sweeping the composite ply to the tool.
